(19) United States
(12) Patent Application Publication
(10) Pub. No.: US 2007/0168377 A1
(43) Pub. Date: Jul. 19, 2007

(54) Method and apparatus for classifying Internet Protocol data packets

(75) Inventor: Boris Zabarsky, Tel Aviv (IL)

Correspondence Address: EMPK & SHILOH, LLP, 116 John St., Suite 1201, New York, NY, 10038, US

(73) Assignee: Arabella Software Ltd., Kfar-Saba Industrial Area (IL)

(21) Appl. No.: 11/321,494

(22) Filed: Dec. 29, 2005

(51) Int. Cl. G06F 7/00

(52) U.S. Cl. 707/102

(57) ABSTRACT

A method and apparatus for generating a data structure for classifying an Internet Protocol packet. The data structure generation method may include creating a level-2 table with a plurality of bins for storing therein classification rules and using a first hashing data to derive a hash key1 from a classification rule to point at, or to designate, an entry of a level-1 table, and populating the entry with a pointer to the level-2 table. The method may further comprise populating a bin in the level-2 table with the classification rule, which bin is pointed at, or designated, by a hash key2 that is derived from the rule by using a second hashing data contained in the entry. The method may further include searching the data structure for a classification rule by driving from the packet a hash key1 to point at, or for designating, an entry of level-1 table to obtain a pointer to a level-2 table and hashing data to generate a hash key2 to point at, or for designating, a bin in the level-2 table, where a classification rule suitable for the packet may be found.

### FIELD OF THE DISCLOSURE

The present disclosure generally relates to the field of communication systems. More specifically, the present disclosure relates to a method and apparatus for classifying Internet Protocol (“IP”) packets.

### BACKGROUND

In a digital data network such as the Internet, local area network (“LAN”) and wide area network (“WAN”), data packets are transmitted between a source computer and a destination computer. Source and destination computers can be, for example, routers, servers as well as terminal devices such as personal computers (“PCs”), personal digital assistants (“PDAs”), advanced cellular phones, and the like. A computer/server may be, at times, a source computer/server or a destination computer/server, depending on whether it receives data packets or transmits them.

When data packets are transmitted over a data network from a source computer to a destination computer, they usually traverse routers, firewalls and other types of network components. Such network components may be the final destination for data packets, or they may relay the packets to another intermediate or final destination network device component/computer.

After being received at a network component, a data packet has to be processed by the network component in order for the network component to decide the course of action, or processing rule (hereinafter “rule”, for simplicity), to be taken/selected in respect of the received data packet. For example, based on the packet processing, the network component may decide to further forward the data packet to another network component, immediately or after some delay, as is or after some modifications/manipulations, and so on. According to another example, the network component may decide not to forward the data packet to the final destination, for example if the final destination is unauthorized to receive the data packet(s), and so on.

In order to enable the selection of a rule by a network component, the network component has to “classify” the data packet. Classification of a data packet typically involves evaluation of the data contained within the packet's header and selection of a processing rule, or flow identifier (“flow ID”), from a predetermined set of processing rules/flow IDs. Once a processing rule/flow ID is selected, the data packet may be processed, or otherwise handled, in the way specified, or dictated, by the selected rule/flow ID.

Often, millions of data packets traverse a data network each second and a network component may need to use a large number of rules, sometimes up to or exceeding one thousand rules. Therefore, in order not to exacerbate congestions, network components need to be able to classify and process millions of data packets at a very high speed.

Several techniques are conventionally used for speeding up the classification process of data packets. For example, such techniques are disclosed by U.S. Pat. No. 5,708,695 (“METHOD FOR HASHING IN A PACKET NETWORK SWITCHING SYSTEM”), U.S. Pat. No. 6,700,889 (“HIGH SPEED APPARATUS AND METHOD FOR CLASSIFYING A DATA PACKET BASED ON DATA VALUES CONTAINED IN THE DATA PACKET”), US 2005/0190694 (“METHODS AND APPARATUS FOR WIRE-SPEED APPLICATION LAYER CLASSIFICATION OF UPSTREAM AND DOWNSTREAM DATA PACKETS”).

A hash function (or hash algorithm) is a function for summarizing or probabilistically identifying data. Such a summary is known as a hash value or simply a hash, and the process of computing such a value is known as hashing. A fundamental property of all hash functions is that if two hash values, which were computed using the same hash function, are different, then the two inputs were different in some way. However, the equality of two hash values does not guarantee that the two inputs were the same.

Because of the variety of applications for hash functions, they are often tailored to the application. For example, cryptographic hash functions assume the existence of an adversary who can deliberately try to find inputs with the same hash value. Functions for error detection and correction focus on distinguishing cases in which data has been disturbed by random processes. In any application, a good hash function is a function that yields few hash collisions in expected input domains. In hash tables and data processing, collisions inhibit the distinguishing of data, making records more costly to find.

Hash tables, a major application for hash functions, enable fast lookup of a data record given its “hash key”. Hash keys are used to “unlock” or access information. An efficient method of searching can be to process a lookup key using a hash function, then take the resulting hash value and use it as an index into an array of data. The resulting data array is typically called a hash table. As long as different keys map to different indices, lookup can take substantially the same amount of time. When multiple lookup keys are mapped to identical indices, however, a hash collision occurs. Put otherwise, hash collision is a situation that occurs when two distinct inputs into a hash function produce identical outputs. The most popular ways of dealing with hash collisions are building a linked list of values for each array index, or searching other array indices nearby for an empty space.

Most hash functions have potential collisions, but with good hash functions they occur less often than with bad ones. In certain specialized applications where a relatively small number of possible inputs are all known ahead of time, it is possible to construct a hash function which maps all inputs to different outputs. But in a function which can take input of arbitrary length and content and returns a hash of a fixed length (such as MD5), there will occasionally be collisions, because any given hash can correspond to an infinite number of possible inputs. It is important that excessive collision rates with random hash functions are highly improbable. However, a small number of collisions are virtually inevitable.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantageous or improvements.

As part of the present disclosure a method is provided of generating a data structure for classifying an Internet protocol packet. According to some embodiments the data structure generation may include creating a level-1 table and at least one level-2 table that may contain one classification rule as a start. More specifically, the method may include creating a level-2 table with a plurality of bins for storing therein classification rules and using a first hashing data to derive a first hash key (hash key1) from a classification rule that is intended to be added to the data structure. Then, the hash key1 may be used to point at, or designate, an entry of a created level-1 table, and that entry may be populated with a pointer to the level-2 table. The method may further include populating a bin in the level-2 table with the classification rule, which bin is pointed at by a second hash key (hash key2) that is also derived from the rule by using a second hashing data that is also contained in the entry.

Generation of the data structure may include addition of as many as required new classification rules. According to some embodiments the addition of a new classification rule to the data structure may include deriving a first hash key from the new classification rule, by using a first hashing data, to point at, or to designate, an entry of the level-1 table. The entry may contain a second hashing data and maybe a pointer. A second hash key may be derived from the new rule, by using the second hashing data, for pointing at a bin in a level-2 table pointed at by the pointer or, if such pointer does not exist, for pointing at a bin in a newly created level-2 table. Then, the bin may be populated with the new classification rule and, if the bin resides within a newly created table, the entry may be populated with a pointer to the newly created level-2 table.

As part of the invention, a method is provided of classifying an Internet protocol packet in a data structure. According to some embodiments, the classification method may include deriving a first hash key from the packet, by using a first hashing data, for obtaining a second hashing data and a pointer from an entry in a level-1 table, and deriving a second hash key from the packet, by using the second hashing data, for pointing at a hash bin in a level-2 table pointed at by the pointer. Then, a rule suitable for the packet may be searched for in the hash bin, and the packet may be handled according to a flow identifier associated with the suitable rule.

As part of the present disclosure an apparatus is provided for generating a classification data structure and for classifying an Internet Protocol packet by using the data structure. According to some embodiments the apparatus may include a network processor that coupled to a direct memory access (“DMA”) engine and includes a local memory. The apparatus may further include a control processor coupled to an external memory system.

The control processor may be adapted to generate a classification data structure by populating an entry of a level-1 table, which is pointed at by a first hash key derived from a classification rule by using a first hashing data, with a pointer to a level-2 table and a second hashing data; and populating a bin in the level-2 table with the classification rule, the bin being pointed at by a second hash key derived from the classification rule by using the second hashing data. The control processor may store the level-1 table in the local memory and the level-2 table in the external memory system. The network processor may be adapted to perform the search needed for the packet classification, substantially in the way described herein.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates an exemplary classification data structure according to some embodiments of the present disclosure;

FIG. 2 is an exemplary flowchart for generating, and adding rules to, a data structure according to some embodiments of the present disclosure;

FIG. 3a is an exemplary flowchart for rebuilding a level-2 table according to some embodiments of the present disclosure;

FIG. 3b schematically exemplifies rebuilding a level-2 table according to some embodiments of the present disclosure;

FIG. 4a is an exemplary flowchart for splitting a level-2 table according to some embodiments of the present disclosure;

FIG. 4b schematically exemplifies splitting a level-2 table according to some embodiments of the present disclosure;

FIG. 5 is an exemplary flowchart for deleting a rule from a data structure according to some embodiments of the present disclosure;

FIG. 6a is an exemplary flowchart for merging two level-2 tables according to some embodiments of the present disclosure;

FIG. 6b schematically exemplifies merging two level-2 tables according to some embodiments of the present disclosure;

FIG. 7 is an exemplary flowchart for classifying IP (Internet Protocol) packets according to some embodiments of the present disclosure; and

FIG. 8 schematically illustrates the layout and functionality of the system according to some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The present disclosure may take the form of an entirely hardware embodiment, an entirely software embodiment or an embodiment containing both hardware and software elements. In a preferred embodiment, the disclosure is implemented in software, which includes but is not limited to firmware, resident software, microcode, and so on.

Embodiments of the present disclosure may include apparatuses for performing the operations described herein. This apparatus may be specially constructed for the desired purposes, or it may comprise a general purpose computer selectively activated or reconfigured by a computer program stored in the computer.

Furthermore, the disclosure may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, magnetic-optical disks, a removable computer diskette, a random access memory (RAM), a read-only memory (ROM), a rigid magnetic disk, an optical disk, electrically programmable read-only memories (EPROMs), electrically erasable and programmable read only memories (EEPROMs), magnetic or optical cards, or any other type of media suitable for storing electronic instructions, and capable of being coupled to a computer system bus. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code has to be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Moderns, cable modem and Ethernet cards are just a few of the currently available types of network adapters.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosures as described herein.

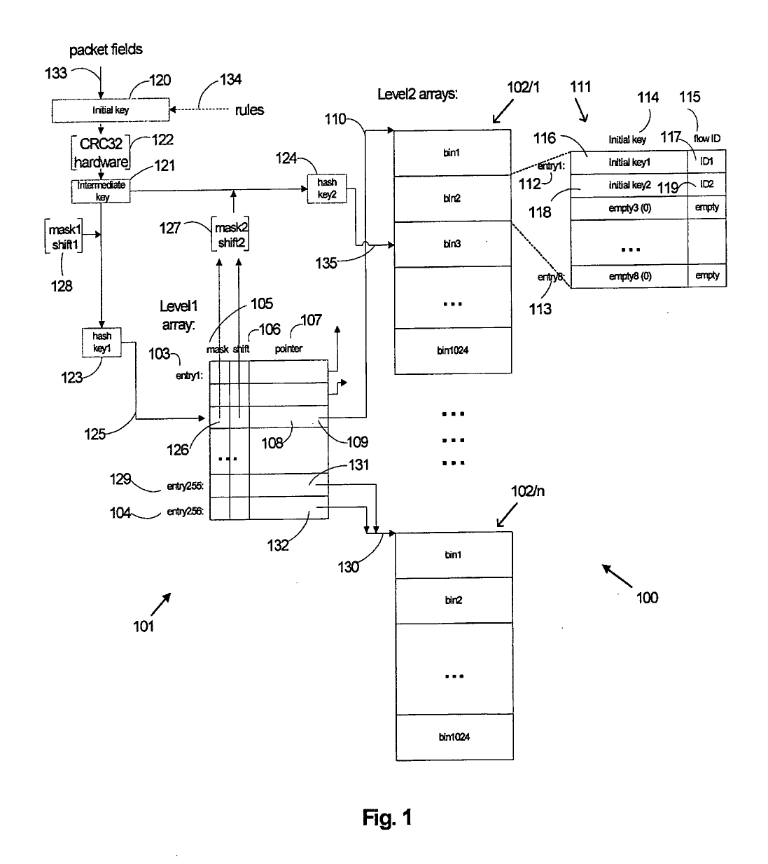

Referring now to FIG. 1, it schematically illustrates an exemplary classification data structure according to some embodiments of the present disclosure. The term “classification rule” generally refers herein to an association between concatenated pre-selected fields of packets, the concatenation forming respective initial keys, to a series of actions (herein referred to as “flow ID”) specified for that packet. Ideally, though other situations may also occur, an initial key may be associated with only one, unique, flow ID. According to some embodiments the concatenation may be applied to four packet's header fields from the IP and TCP/UDP header: IP source address (4 bytes), IP destination address (4 bytes), TCP/UDP source port (2 bytes) and TCP/UDP destination port (2 bytes). The latter four fields may be concatenated in a fixed order to produce 12-byte initial keys. It is noted that the number and type of concatenated fields used to describe the embodiments are merely illustrative. The concatenation can be applied to a different number, and different type, of packets' header fields without deviating from the spirit of the disclosure.

If a flow ID is searched for in the data structure for a received packet, then the initial key 120 may be derived from pre-selected fields of the received packet (133). If it is desired to update the data structure; that is, it is desired to add, or remove, a classification rule to/from a data structure, then the initial key 120 may be derived from the same pre-selected fields of the rule being added or removed (134).

Classification data structure 100 may consist of level-1 table such as level-1 table 101, and one or more level-2 102/i tables (where i=1, 2, . . . , n). Level-1 table 101 is shown consisting of 256 entries, entry1 (103) to entry256 (104), though this is not necessarily so. For example, a level-1 table may have 128 or 512 entries, for example. The number of entries of the level-1 table depends on the classification scheme in the way described and exemplified hereinafter. Each entry of exemplary level-1 table 101 may consist of at least three fields: “mask” (105), “shift” (106) and “pointer” (107). The pointer field of a given entry of level-1 table 101 may contain a level-2 table identifier to point to a level-2 table 102/i. For example, pointer field 108 is shown containing a level-2 table identifier 109 that points (110) to level-2 table 102/1. The maximum number of level-2 tables (n) equals the number of entries of level-1 table 101. According to some embodiments, a classification data structure, such as data structure 100, may be generated and thereafter updated as described hereinafter. Updating a data structure includes addition and removal of new/existing classification rules to/from the data structure, respectively, whichever the case may be.

Referring now to exemplary level-2 table 102/1, each entry of level-2 table 102/1 is structured as a hash “bin”. A hash bin is a data entity that may consist of up to a predetermined maximum number of entries, and the entries of a given bin all have the same address, which is the address of the bin or related level-2 table's entry. The number of hash bins in a level-2 table depends on the classification scheme in the way described and exemplified hereinafter. For example, exemplary hash bin 111 is shown consisting of maximum of eight entries, entry1 (112) to entry8 (113). Each entry of exemplary hash bin 111 may be constructed from at least two fields: “Initial key” (105) and “Flow ID” (115). Exemplary bin 111 is shown having only two classification rules: the first rule associates “Initial key 1” (116) with flow ID “ID1” (117), and the second rule associates “Initial key 2” (118) with flow ID “ID1” (119). The other entries of bin 111 (for example entry8 (113)) are empty; that is, their “Initial key” and “flow ID” fields are empty, or cleared.

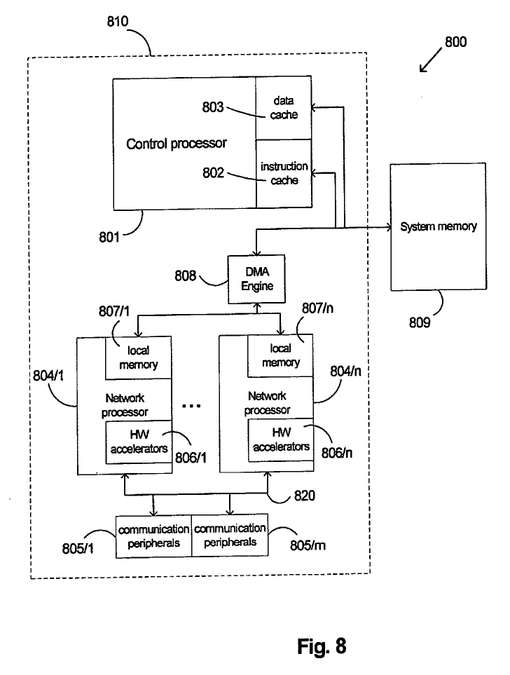

According to some embodiments, each classification rule is an association between a unique “Initial key” value that may typically be represented by 12 to 16 binary bytes, and a “flow ID” result value that may typically be represented by two binary bytes. According to some embodiments, the level-2 tables 102/1 to 102/n are stored in an external memory of a classification system, whereas the level-1 table 101 is stored in an internal memory of the classification system, as described in connection with FIG. 8.

According to some embodiments, each hash bin in a level-2 table may consist of 128 binary bytes, for example, that are partitioned to eight groups (entries) of 16 bytes, for example. Some entries in each bin (the first 1-8 entries) may each contain a classification rule in the form of an initial key, which may consist of 12 bytes (for example), associated with a result flow ID, which may consist of 2 bytes (for example).

According to some embodiments, initial key 120 may be hashed, for example by being CRCed (122), to obtain an intermediate hash key 121. Hash key1 (123) and hash key2 (124) may each be calculated from the intermediate hash key 121 by using first hash key parameters and second hash key parameters, respectively. The second hash key parameters may be stored in a corresponding entry of level-1 table as hashing data. Being a binary string (for example, 1001110), the intermediate hash key 121 may be hashed, for example, by masking it and, thereafter, by bit-wise shifting the resulting masked string, the masking and shifting being denoted as “mask1” and “shift1” (128), respectively, and by “mask2” (105) and “shift2” (106), respectively. Hash key1 123 may point (125) at a specific entry of level-1 table 101, and hash key2 124 may point (135) at a specific bin of level-2 table 102/1 (bin3, in this example).

Seldom, there might be cases where an attempt to add a new classification rule to a certain hash bin will result in exceeding the maximum allowed number of classification rules in that hash bin, a situation that is commonly known in the art as “bin explosion”, or “bin overflow”. According to some embodiments, whenever a bin explosion occurs, the classification data structure will be re-organized to eschew explosion. By “re-organized” is meant herein iteratively rebuilding the level-2 table and/or splitting a level-2 table, until the explosion problem is rectified, which means that no bin explosion occurs in the re-organized data structure when the new rule is added to the re-organized data structure.

More than one pointer may point at a certain level-2 table. For example, exemplary level-2 table is shown pointed at (130) by pointer (level-2 table identifier) 131 and pointer (level-2 table identifier) 132, which reside in two different entries, 129 and 104, respectively, of exemplary level-1 table 101.

Using two or more pointers to point at the same level-2 table is useful for saving memory space. That is, if a level-2 table is sparsely populated with rules, then, instead of creating a new level-2 table for additional rules, the same old level-2 table may be used also for holding these additional rules, up to a certain number of rules. Under such circumstances, the old level-2 table may be pointed at by more than one pointer. On the other hand, if a level-2 table which is pointed at by two or more pointers gets dense, then some of the rules in that table may be transferred to one or more new level-2 tables and pointer(s) which previously pointed at the old, now dense, level-2 table, may be overridden by pointers pointing at the new one or more level-2 table.

If a bin explosion occurs during an attempt to add a new rule to data structure 100 and the explosion cannot be rectified by rebuilding the level-2 table involved in the explosion, then the explosion may be rectifiable if the level-2 table is pointed at by more than one pointer. The rebuilding and splitting procedures used for explosion rectification are described in details hereinafter.

Adding a Rule to a Hash Bin

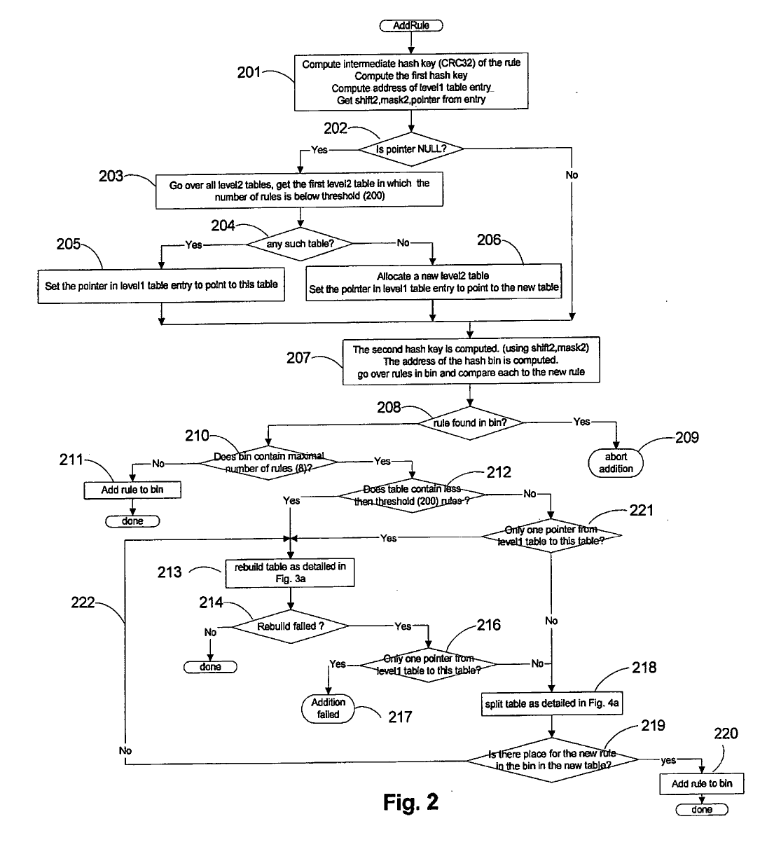

Referring now to FIG. 2, it shows an exemplary rule addition flowchart for adding a new classification rule to a classification data structure. Various steps in FIG. 2 will be described in conjunction with FIG. 1 to facilitate understanding of the addition procedure. The generation of a classification data structure begins by allocating a level-1 table, such as level-1 table 101 (FIG. 1), and by initially setting all of its level-2 pointers to “Null” value.

According to some embodiments, a first step in generating a classification data structure is adding to it a first classification rule. A first classification rule is added to the data structure by concatenating pre-selected fields of the classification rule, to create therefrom an initial key (120, FIG. 1). At step 201, the initial key (120, FIG. 1) may be hashed by a first hash function to obtain an intermediate hash key (121, FIG. 1). For example, the initial key (120, FIG. 1) may be hashed by being CRC'ed, by using CRC32 hardware (122, FIG. 1). The intermediate hash key (121, FIG. 1) may then be utilized for generating a first hash key (123, FIG. 1) and a second hash key (124, FIG. 1), by using first hashing parameters (128) that specify the “shifting” and “masking” (according to the exemplary embodiment) for the binary-wise intermediate hash key (121, FIG. 1). The shifting and masking mechanism used for generating the first hash key are herein referred to as the “first hash key parameters”, or “first hashing data”. Likewise, the shifting and masking mechanism used for generating the second hash key is herein referred to as the “second hash key parameters”. The first hash key parameters and the second hash key parameters may not necessarily be identical. Furthermore, different level-1 table entries may contain different second hash key parameters, or “second hashing data”. More generally, entries of a level-1 table are independent of one another as far as second hashing data are concerned.

The first hash key (123) may point at an entry of the level-1 table 101, which may contain hashing data (second hash key parameters) and a pointer to point at a level-2 table. For example, the exemplary first hash key 123 is shown pointing (125, FIG. 1) at entry 126 of level-1 table 101. Still at step 201, the second hash key parameters and a pointer contained in the pointed at entry are fetched. If the value of the fetched pointer is “Null”, a condition that is checked at step 202, then, according to step 203, a first level-2 table, which will be a candidate for hosting the new classification rule, is searched for. A first level-2 table will be a candidate for hosting the new classification rule if the number of rules it currently hosts is smaller than some predetermined value. If a candidate level-2 table is found, a condition that is checked at step 204, then, according to step 205, the pointer field in the entry (of the level-1 table 101) pointed at by the first hash key is assigned a level-2 table identifier, to point at the candidate/found level-2 table 102. However, if no level-2 table is found at step 203, then, at step 205, a new level-2 table is created and the pointer field in the entry (of the level-1 table 101) pointed at by the first hash key is assigned a level-2 table identifier that points at the newly created level-1 table.

Once the entry pointed at by the first hash key is connected to (it points at) the found, or newly created, level-2 table, a second hash key (124) is computed, at step 207, by utilizing the second hashing parameters (127) contained in the mask and shift fields (105 and 106, respectively) of the entry pointed at by the first hash key (hash key 1). Still at step 207, the second hash key (hash key2, 124) may then be utilized to point at the corresponding hash bin in the found, or newly created, level-2 table. Then, the classification rule is searched for in the bin. If the classification rule is found in the bin, a condition that is checked at step 208, then, according to step 209, the rule addition session is aborted. However, if the rule is not found in the bin, then the classification rule will be added to the bin, at step 211, if that bin currently contains a number of classification rules that is smaller than a certain predetermined number, a condition that is checked at step 210.

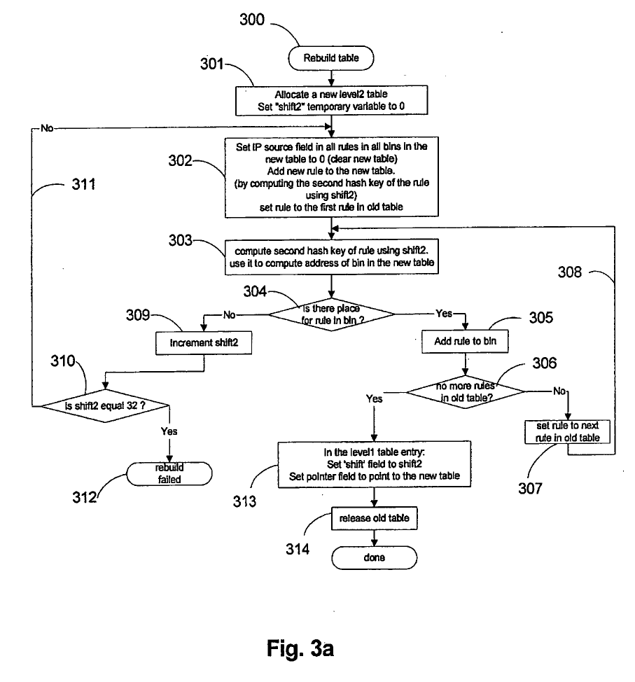

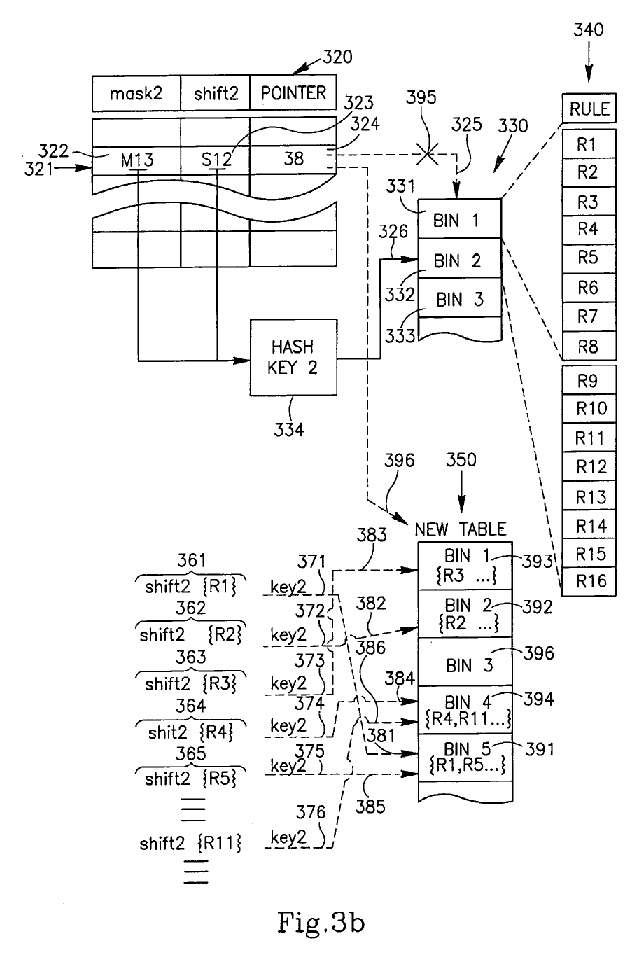

If, at step 210, it is found that the bin's capacity has already been exhausted, which means that it cannot contain one more (the new) classification rule, then the found, or newly created, level-2 table is rebuilt for accommodating the new classification rule, at step 213. However, level-2 table will be rebuilt if the found, or newly created, level-2 table contains, at that point, less than a predetermined number of classification rules, a condition that is checked at step 212. The way a level-2 table is rebuilt is described hereinafter, in connection with FIG. 3a. If the level-2 table can be rebuilt (214), then the new classification rule may be added to a corresponding bin in the rebuilt level-2 table 102/i in the way described in connection with FIG. 3a.

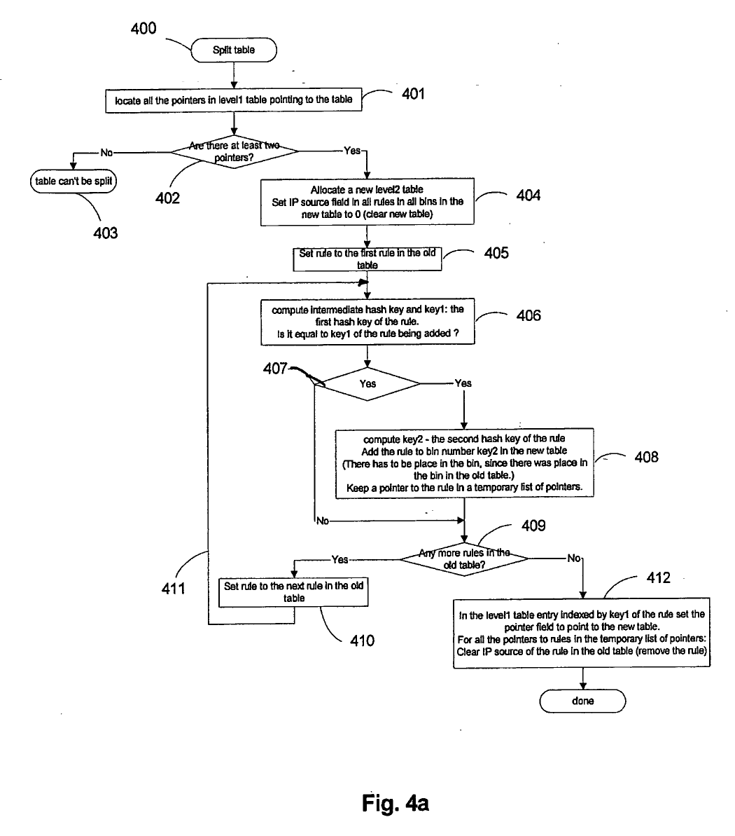

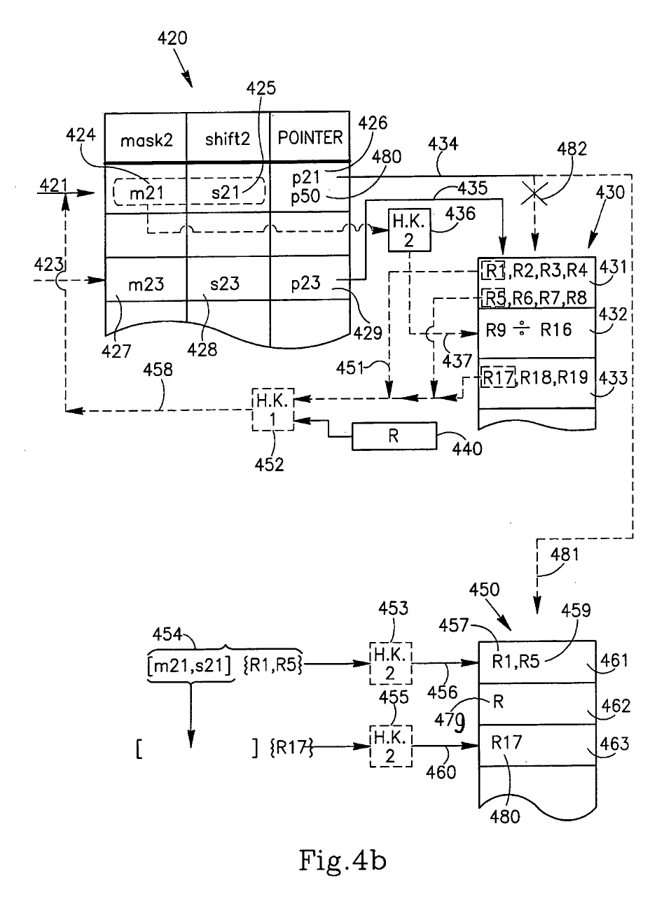

If the level-2 table 102/i is pointed at by only one pointer from the level-1 table 101, a condition that is checked at step 216, then, according to step 217, the rule's addition has failed. However, if the level-2 table 102/i is pointed at by more than one pointer from the level-1 table 101, then, according to step 218 the level-2 table 102/i is split, as described hereinafter in connection with FIG. 4.

If there is place in the new table for the new classification rule, a condition that is checked at step 219, then, according to step 220, the new classification rule is added to a bin in the new table. However, if there is no place in the new table for the new classification rule (219), then the step of rebuilding the table (step 213) is repeated, except that now the rebuilding procedure is employed on a different table; that is, on a new level-2 table that has been created during the splitting step 218.

Turning again to step 212, if the level-2 table does not contain less than a predetermined number of classification rules, then the level-2 table is split (218) if more than one pointers from the level-1 table 10 point at the level-2 table 102/i, a condition that is checked at step 221. However, if more than one pointers from the level-1 table 10 point at the level-2 table 102/i, then the table rebuilding step 213 may be repeated. Loop 222 may be repeated, from the “rebuilding” procedure (step 213) to the “splitting” procedure (218) until a rebuilt table, or a split table (whichever the case may be), can contain the new classification rule.

Re-Building a Level-2 Table

Referring now to FIG. 3a, it exemplifies a way for rebuilding an existing level-2 table according to some embodiments of the present disclosure. Reference numeral 300 is similar to reference numeral 213 of FIG. 2. Throughout the description that pertains to FIG. 3a, whenever a second hash key is said to be computed for an exported rule by using a shift2 parameter, it means that a mask2 parameter is also used in the computation process. The mask2 parameter is obtained at step 201 of FIG. 2, and it remains constant during the entire rebuilding procedure, whereas the shift2 may change as explained hereinafter.

According to some embodiments, an existing level-2 table is rebuilt if one of its hash bins overflows during an attempt to add a new rule. That is, if a hash bin to which a new classification rule is to be added cannot contain the new rule (because the bin already contains the predetermined maximum number of rules), then the entire level-2 table that contains that hash bin will have to be rebuilt. By “rebuilding” a table is meant herein re-arrangement of the rules in the table such that no bin in the (rebuilt) table would overflow as a result of an addition of a new rule. A level-2 table may be rebuilt as many times as required. The rules may be re-arranged in the level-2 table by using a corresponding shift2 parameter. It is noted that both the shift2 and mask2 parameters can be manipulated to rebuild a level-2 table. However, while the mask2 parameter controls mainly the size of the level-2 table, the shift2 parameter controls the distribution (re-arrangement) of rules among bins of the level-2 table. In other words, a new shift2 parameter is chosen, on a trial-and-error basis, which yields non-overflowing bins when used to calculate new addresses (new addresses being sometimes referred to herein as “key2”) for the rules in the bins. According to some embodiments, rebuilding a table is implemented in three main stages. In the first stage, a new level-2 table is created. In the second stage, the rules of the old level-2 table (the original table to be rebuilt) are re-arranged in the newly created level-2 table, and in the third stage, the old level-2 table is removed/deleted from the classification data structure.

Accordingly, at step 301, a new level-2 table is created and allocated, to which the rules currently contained in the old level-2 table will be copied. At step 302, the values in the “shift2” temporary variable is initially cleared, by setting it to 0. From this stage on, the procedure for re-arranging the rules currently stored in the old level-2 table is described. It may be said that the rules in the old level-2 table are copied to a new level-2 table, where they might be arranged in a different order comparing to their order in the old level-2 table.

Still at step 302, the new rule (that is yet to be added to the data structure) is added to the newly created level-2 table. Thereafter, the first rule in the old table may be obtained and, at step 303, a new second hash key may be computed for the first rule (hereinafter “Rule-1”) by using the “shift2” temporary variable from step 301, which points to a bin in the new level-2 table. Since the new level-2 table includes only the new rule at this stage, there is a place in the corresponding bin for Rule-1, a condition that is checked at step 304. Therefore, at step 305, Rule-1 is added to the bin. If there is a second rule (hereinafter “Rule-2”) in the old level-2 table, a condition that is checked at step 306, then this rule is obtained from the old level-2 table (at step 307), and the “shift2” parameter of step 301 is employed on Rule-2, at step 303, to compute a second hash key for Rule-2. The second hash key that is computed for Rule-2 points to a bin in the new level-2 table, to which Rule-2 may be added if that bin is not yet full. Copy loop 308 may be repeated for every rule in the old level-2 table that has not been yet exported, or copied, to the new level-2 table, provided that no bin overflow has occurred in any of the bins involved in the rules copying (or exportation) process.

Turning again to step 304, if a rule in the old level-2 table cannot be exported to its intended bin (the bin pointed at by the related second hash key), due to bin overflow problem, then the “shift2” variable is incremented, at step 309. If the shifting variable meets a predetermined criterion, a condition that is checked at step 310, then step 302, and the steps following step 302, may be repeated. That is, the new level-2 table is cleared, and another attempt is made to export the rules from the old level-2 table to the new level-2 table. If the “shifting” loop 311 has been exhausted and there is still at least one rule that could not be exported to any one of the bins (the condition being checked at step 304 for each iteration of shifting loop 311), then the rebuilding procedure is considered “failed” (at step 312).

Turning again to exportation loop 308, if all of the rules have been successfully exported to the new level-2 table, a condition that is checked at step 306, then, at step 313, the last known value of shift2 and a pointer to the new level-2 table are inserted into the entry of the level-1 table. The “last known value of shift2” refers to the shift2 value that was used in the first successful exportation of the entire rules from the old level-2 table to the new level-2 table. The “entry of the level-1 table” is the entry pointed at by the first hash key at step 201 of FIG. 2, and the last known value of shift2 and the pointer are inserted into that entry's shift2 field and pointer field, respectively.

It is noted that rebuilding a level-2 table is a task performed by a control processor while a network processor may concurrently utilize the data structure for ongoing packet classifications. For allowing ongoing packet classifications, the data structure has to remain valid and correct at all times to eschew misclassifications. Regarding the control and network processors, a more detailed description thereof is given hereinafter in connection with FIG. 8. Accordingly, the pointer to the old level-2 table and the shift value (and optionally the mask value) contained in the entry of the level-1 table are not replaced by new respective values until the new level-2 table is ready. That is, only after every rule has been successfully copied from the old level-2 table to the new level-2 table, the new shift2 value and the pointer to the new level-2 table replace the current shift2 and pointer in the level-1 table entry. It is also noted that both shifts and pointer replacements/updates are done substantially at the same time, so that the network processor may continue to correctly classify ingress data packets.

Referring now to FIG. 3b, it demonstrates re-building of a level-2 table according to some embodiments of the present disclosure. Various steps in FIGS. 2 and 3a will now be described in conjunction with FIG. 3b to facilitate the understanding of the level-2 table rebuilding procedure. Level-1 table 320 generally has a plurality of entries such as exemplary entry 321. Exemplary entry 321 is shown containing exemplary hashing data (322 and 323). The hashing data may consist of an exemplary second-level mask identifier m13 (322) and an exemplary second-level shift identifier S12 (323), and a pointer 38 (324). Pointer 38 (324) is shown pointing at an exemplary level-2 table 330. Level-2 table 330 consists of a plurality of bins, only three of which are shown, Bin1 (331), Bin2 (332) and Bin3 (333). A second hash key (334) is obtained by applying m13 (322) and S12 (323) (the hashing data) to an intermediate hash key that is derived from the rule to be added. The second hash key (334) points (326) at Bin2 (332) and, therefore, according to the flowchart of FIG. 2, the rule is initially intended to be added to bin2 (332). By “initially intended” is meant addition of the rule to Bin2 (332) only if bin2 (332) is not yet fully populated with other rules (a condition that is checked at step 210 of FIG. 2). It is assumed that the number of rules that is allowed in each bin of level-2 table 330 is limited to a predetermined maximum number of eight rules (for example). Therefore, bin2 (332) is considered full, because it already contains the maximal allowed number of rules (eight rules, R9 to R16, 340) and, therefore, a new rule cannot be added to Bin2 (332) for tack of place.

As shown in FIG. 3b, level-2 table 330 is shown having only sixteen rules (R1 to R16, 340). Bin1 (331) contains rules R1 to R8, inclusive, and Bin2 (332) contains rules R9 to R16, inclusive. Assuming that the sixteen rules R1 to R16 (340) are less than a predetermined number of maximum rules, say 200 rules (for example), then, according to step 212 of FIG. 2, level-2 table 330 may be rebuilt, as specified in connection with step 213 of FIG. 2 and demonstrated by FIG. 3b. Rebuilding level-2 table 330 may start by creating and allocating a new level-2 table 350 and initially setting the value of a temporary variable “shift2” (not shown) to an initial value, to zero for example (step 301 of FIG. 3a).

A temporary variable “shift2” is used (at step 301) in order to ensure that entry 321 of level-2 table 320 contains the current hashing data m13 and S12 (322 and 323, respectively) and pointer 38 (324) to enable packets classifications while the level-2 table 330 rebuilding process is in progress. Once the level-2 table rebuilding process is successfully completed; that is, each one of the rules (including the new rule) has been successfully copied from a bin in the old level-2 table 330 (or inserted) into a bin in the new level-2 table 350 (by using the value of shift2 that was last computed at step 309), the current shift S12 (323) may be substituted with the last value of shift2, and the current pointer that currently points at the old level-2 table 330 may be substituted with a pointer to point (396) at the new level-2 table 350. This way, level-2 table 330 is disconnected (395) from entry 321 of level-1 table 320 and level-2 table 350 is connected (396) in its stead. Preferably, substitution of the current shift2 and pointer (in entry 321) with the new respective values is carried out substantially at the same time to enable smooth operational transition from the old (now irrelevant level-2 table 330) to the new level-2 table 350, to thereby eschew packets misclassifications.

Before adding rules to new level-2 table 350, all of the new level-2 table 350 entries in all of its bins may be initially cleared, such as by setting all of the IP (Internet Protocol) source fields to zero, which is an invalid value for IP source (step 302). Then, still at step 302, the first rule in the old level-2 table 330 (rule R1 in bin1) is fetched and the initial shift value (zero at this stage, according to step 301) is applied to R1 (361) to generate a corresponding second hash key 371 similar to hash key 334. As demonstrated in FIG. 3b, key2 371 points (381) at exemplary bin5 (391). Since, at this stage, bin5 (391) is still empty, there is a place in bin5 (391) for rule R1, a condition that is checked at step 304. Therefore, rule R1 from the old level-2 table 330 may be added to bin5 (391), as specified at step 305.

Since there are other rules in level-2 table 330, a condition that is checked at step 306, the next rule R2 is fetched from level-2 table 330, as specified at step 307. The initial shift value (still zero at this stage, according to step 301) is now applied to R2 (362) to generate a corresponding second hash key 372 similar to hash key 334. As demonstrated in FIG. 3b, key2 372 points (382) at exemplary bin2 (392). Since, at this stage, bin2 (392) is still empty, there is a place in Bin2 for rule R2, a condition that is checked at step 304. Therefore, rule R2 from the old level-2 table 330 may be added to Bin2 (392), as specified at step 305.

The same initial shift value is applied (363, 364, 365, and so on) to the remaining rules R3 to R16 (340). Provided that none of the bins involved in the addition is full, rules R3 to R16 will be added to the bins pointed at (383, 384, 385, and so on, respectively) by the respective resulting second hash keys 373, 374, 375, and so on. For example, rule R3 may be inserted into bin1 (393), which is pointed at (383) by second hash key 373. It may occur that one or more of the bins of the new level-2 table 350 will contain more than one rule. For example, bin5 (391) may contain rules R1 and R5 because the same initial shift value applied to them created, according to the demonstration, the same second hash key. That is, according to the demonstration, second hash key 371 and second hash key 375 are identical.

If a rule from the old level-2 table 330 needs to be added to the new level-2 table 350 and the bin to which it is intended to be added is already fully populated, then, according to step 309, a different value is chosen for shift2. The condition of a bin being fully populated is checked at step 304. After setting a new value to shift2, the new level-2 table 350 is cleared and the rules R1 to R16 (340) of the old level-2 table 330 are added to the new level-2 table 350, one rule at a time and provided that no bin explosion occurs. Every time a bin explodes before the transfer of rules R1 to R16 is completed, shift2 is assigned a new value.

Then, according to step 313, the last shift2 value that was used in the successful transfer of the entire rules from level-2 table 330 to level-2 table 350 is inserted into the shift2 field 323 as the new valid value, instead of the now invalid value S12. Likewise, a corresponding pointer is inserted into the pointer field (324) to point at (396) the new level-2 table 350, instead of the now invalid pointer 38. Then, the old level-2 table 330 may be released, or deleted/removed from the data structure of which it was part. Bin3 (396) is shown empty at this stage because no rule has yet been copied, or transferred to it from the old level-2 table 330.

As demonstrated by FIG. 3b, if a bin explodes during an attempt to add a new rule, this means that the shift2 value currently in use is no longer acceptable and, therefore, shift2 has to be reassigned a new value. In other words, should a bin explosion occur, shift2 will be assigned a new value to re-arrange the rules in the bins of level-2 table 350 in such a way that no explosion will occur in any of the bins during an attempt to add a new rule. One way of reassigning a value to shift2 is by incrementing its value, as shown at step 309. If a value is found for shift2, for which no bin explosion(s) occur, that value will be stored in, or inserted into, shift2 field 323 of entry 321 of level-1 table 320 as the new valid value. If it is desired to add an additional new rule to one of the bins of level-2 table 350 and that bin explodes, then the rebuilding procedure may be employed in the same manner as described hereinbefore. However, this time level-2 table 350 will be the old table and the rules already contained in level-2 table 350 will be “transferred” (copied) to a new level-2 table (not shown). The new rule may be added to the new level-2 table 350 (at step 305 FIG. 3a) at the beginning of each table transfer, including the last successful transfer.

Splitting a Level-2 Table

Referring now to FIG. 4a, it exemplifies a way for splitting a level-2 table, according to some embodiments of the present disclosure. Reference numeral 400 is similar to reference numeral 218 of FIG. 2. A pre-requisite to splitting a level-2 table is that the level-2 table serves (linked to) more then one level-1 table entry; that is, the level-2 table is a table pointed at by two or more pointers from the level-1 table. Generally speaking, there are two cases in which a level-2 table needs to be split into two level-2 tables during an addition of a rule:

1) Whenever the level-2 table contains more then a threshold number of rules (500 rules for example). In this case, the hash bins will become denser on the average, and the average search time might get longer; and

2) Whenever a hash bin explodes (overflows); meaning that no more rules can be added to it, and rebuilding the level-2 table cannot solve the bin explosion problem.

If it is determined that the level-2 table, to which a new rule is to be added, should be split to rectify an explosion problem, then the splitting procedure may start by locating, or identifying, all the pointers in the level-1 table that point at the level-2 table (at step 401). If only one such pointer is found/identified, a condition that is checked at step 402, then, according to step 403 the level-2 table cannot be split. However, if two or more pointers point at the level-2 table, then, the level-2 table may be split, which means that some of the rules in the (old) level-2 table may be transferred to a new level-2 table, for making room for the rule to be added.

At step 404, a new level-2 table is created and allocated, with all of its bins cleared, such as by setting their values to zero. Then, at step 405, the first rule (symbolically referred to as “R1”) is searched for in the original or old level-2 table. At step 406, the intermediate hash key and the first hash key (hash key1) are computed for R1. Then, the hash key1 of R1 is compared to the hash key1 of the rule to be added. If the two hash keys1 are identical, a condition that is checked at step 407, then, at step 408, the hash key2 of R1 is also computed and R1 is inserted into a bin in the new level-2 table that is pointed at by the computed hash key2 of R1. In addition (still at step 408), a pointers' list is temporarily created, in which a pointer to the copied rule (R1, at this stage) is stored.

If there are more rules in the old level-2 table, a condition that is checked at step 409, then, at step 410, the next rule (symbolically referred to as “R2”) in the old level-2 table is obtained. Then, step 406 is repeated with R2, that is, the hash key1 of R2 is computed and compared to the hash key1 of the rule to be added, and so on, as described in connection with the copying of R1. Copying loop 411 may iterate for additional rules in the old level-2 table while, for each rule that is copied to the new level-2 table, a pointer to that rule is stored in the pointers' list.

If the hash key1 computed for a given rule in the old level-2 table differs from the hash key1 of the rule to be added, a condition that is checked at step 407, then the next rule is obtained from the old level-2 table (at step 410). The old level-2 table is checked for the next rule at step 409. If, however, there are no more rules to be copied from the old level-2 table to the new level-2 table (step 409), then it may be said that the copying of rules to the new level-2 table has been completed.

Splitting of the old level-2 table may be considered completed (at step 412) after: (1) insertion of a pointer to the new level-2 table into the entry of the level-1 table pointed at by the hash key1 of the rule being added, and (2) removal of the copied rules (R1, R2, and so on) from the old level-2 table. That is, copied rules are removed from the old level-2 table while utilizing the pointers' list. For example, in order to remove R1 from the old level-2 table, R1 can be found in the old level-2 table by using a corresponding pointer that was stored in the pointers' list at the time R1 was copied to the new level-2 table, as described hereinbefore. By “removing a rule from the old level-2 table” is meant herein clearing the IP (Internet Protocol) source address field of the (removed) rule in the old level-2 table.

Referring now to FIG. 4b, it demonstrates splitting a level-2 table according to some embodiments of the present disclosure. Various steps in FIGS. 2 and 4a will now be described in conjunction with FIG. 4b to facilitate the understanding of the level-2 table splitting procedure. It is noted that in cases where more than one pointer point at a level-2 table, the rules in a given bin in the level-2 table may have “reached” (entered into) the bin by use of different second hashing data.

Level-1 table 420 may consist of a plurality of entries such as exemplary entries 421 and 423. Exemplary entry 421 is shown containing exemplary hashing data, which may consist of an exemplary mask2 parameter m21 (424) and an exemplary shift2 parameter S21 (425). Entries of level-1 table 420 may contain also a pointer. For example, exemplary entries 421 and 423 are shown containing pointer p21 (426) and pointer p23 (429), respectively. Pointer p21 (426) is shown pointing (434) at an exemplary level-2 table 430 and pointer p23 (429) is also shown pointing (435) at level-2 table 430. Therefore, in this example, pointers p21 (426) and p23 (429) are equal because they both point at the same level-2 table 430. Level-2 table 430 may consist of a plurality of bins, only three of which are shown, bin1 (431), bin2 (432) and bin3 (433). For illustration purpose, bin1 (431) is shown containing rules R1 to R8, and bin2 (432) is shown containing rules R9 to R16. Likewise, bin3 (433) is shown containing rules R17, R18 and R19.

It is assumed that an exemplary rule, symbolically represented as 440, is a rule that is intended to be added to level-2 table 430. In an attempt to add rule 440 to the data structure, a first hash key (441) is generated, or derived, from rule 440 in the way described hereinbefore. First hash key 441 is schematically shown as pointing, for example, at entry 421 of level-1 table 420, which contains pointer p21 (426) that points (434) at level-2 table 430. A second hash key (436) is obtained by applying hashing data, in this example m21 (424) and S21 (425), to an intermediate hash key (such as intermediate key 121 of FIG. 1), that is derived from rule 440.

The second hash key (436) points (437) at bin2 (432) and, therefore, according to the flowchart of FIG. 2, the rule is initially intended to be added to bin2 (432). By “initially intended” is meant addition of the rule to bin2 (432) only if bin2 (432) is not yet fully populated with other rules (a condition that is checked at step 210 of FIG. 2). It is assumed that the number of rules that is allowed in each bin of level-2 table 430 is limited to a pre-determined maximum number of rules, say eight rules (for example). Therefore, bin2 (432) is considered to be full because it already contains the maximal allowed number of rules (eight rules, R1 to R8) and, therefore, rule 440 cannot be added to bin2 (432) due to lack of place (due to bin explosion).

Because this is not clearly shown in FIG. 4b, it is assumed that exemplary level-2 table 430 contains more than a pre-determined recommended maximum number of rules, a condition that is checked at step 212 of FIG. 2. The predetermined maximum number of rules allowed in a level-2 table may be 200 rules, for example. Therefore, if two or more pointers point at level-2 table 430, a condition that is checked at step 221 of FIG. 2, then, level-2 table 430 is a candidate for splitting, as specified at step 218 of FIG. 2 and demonstrated by FIG. 4b. In general, if a level-2 table contains too many rules (more than the pre-determined maximum number of rules) and two or more pointers point to that level-2 table, then some of the rules in that level-2 table may be transferred (“split away”) to a new level-2 table. If two or more pointers point at the same level-2 table, this means that the rules in the level-2 table can potentially be divided between a number of level-2 tables that is identical to the number of pointers, on a table-per-pointer basis. That is, in a general case, rules associated with a first, second, third (and so on) pointer, may be transferred to a respective second level-2 table, third level-2 table (and so on), if so desired or required, whereas rules associated with the first pointer may be left in the first, original, level-2 table. This way (using multiple level-2 tables), the number of rules in each one of the level-2 tables (the original table and the new tables) will be less than the pre-determined maximum number of rules recommended for a level-2 table. Put differently, splitting a level-2 table is intended to transform a relatively densely populated table into a sparsely populated table, for making room in the transformed table for additional new rules.

Referring again to FIG. 4b, it is assumed that each one of the rules in level-2 table 430 is associated with one of two entries; that is, with entry 421 (by pointer p21) or with entry 423 (by pointer p23). However, the two hashing data associated with these two entries; that is, hashing parameters 424 and 425 (for entry 421) and hashing parameters 427 and 428 (for entry 423), may generate, after applying them to the rules, different second hash keys (hash key2). For this reason, rules in a level-2 table can potentially populate a number of bins that may be greater than the number of the pointers pointing to that level-2 table.

Pointer p21 (426) points (434) at level-2 table 430, and pointer p23 (429) also points (435) at level-2 table 430. As stated hereinbefore, it is assumed that level-2 table 430 contains more than the recommended maximum number of rules. Therefore, level-2 table 430 may be split, if so desired or required, as described hereafter. Splitting level-2 table 430 may start by locating all of the pointers in level-1 table 420 that point at level-2 table 430 (step 401 of FIG. 4a). According to this example, there are two pointers, p21 (426) and p23 (429), that point (431 and 432, respectively) at level-2 table 430, which complies with condition 402 (FIG. 4a). Accordingly, at step 404 of FIG. 4a, a new level-2 table 450 is created. Level-2 table 450 is partially shown having bin1 (461), bin2 (462) and bin3 (463). Before rules are added to new level-2 table 450, all of the new level-2 table 450 entries in all of its bins are initially cleared (still at step 404), such as by setting all of the IP (Internet Protocol) source fields of the table to zero value. A zero value serves as a clearing value because it is an invalid value as far as IP sources are concerned.

Then, at step 405 of FIG. 4a, the first rule (rule R1 in bin1, in this example) in the (original or old) level-2 table 430 is fetched (451) and a first hash key (hash key1) is computed (452) for R1, at step 406. The first hash key (hash key1, 452) relating to R1 in bin1 (431) is, according to this example, equal to the first hash key associated with the added rule 440. Therefore, the hashing parameters m21 (424) and S21 (425) contained in entry 421, which is associated with rule 440, are applied (454) to R1 to compute a second hash key (hash key2, 453) to point at (456) bin1 (461) of level-2 table 450 to which R1 is inserted or copied (457). Equality between the two first hash keys is checked at step 407 of FIG. 4a. If the two first hash keys are identical (454), this means that both hash keys point (458) at the same entry 421 of level-1 table 420. Computing the corresponding second hash key (453) for rule R1 in bin1 (431) is performed at step 408 of FIG. 4a.

Since there are other rules in level-2 table 430, a condition that is checked at step 409, the next rule R2 is fetched from level-2 table 430, as specified at step 410 and the first hash key for that R2 is also computed. If the first hash key for R2 is not identical to the first hash key of rule 440 (the rule to be added), then a second hash key will not be computed for R2 but, rather, the next rule in the level-2 table will be fetched and evaluated, and so on. According to demonstration of FIG. 4b, the next rule whose computed first hash key (452) is identical to the first hash key of rule 440 is rule R5 in bin1 (431) of level-2 table 430. Accordingly, the hashing parameters m21 (424) and S21 (425) contained in entry 421 are also applied (454) to R5 to compute a second hash key (hash key2, 453) to point at (456) bin1 (461) of level-2 table 450 to which R5 is inserted or copied (459). Equality between the two first hash keys is likewise checked at step 407 of FIG. 4a.

According to demonstration of FIG. 4b, the next rule whose computed first hash key (452) is identical to the first hash key of rule 440 is rule R17 in bin3 (433) of level-2 table 430. Accordingly, the hashing parameters m21 (424) and S21 (425) contained in entry 421 are also applied (454) to R17 to compute a second hash key (hash key2, 455) to point at (460) bin3 (463) of level-2 table 450 to which R17 is inserted or copied (470). Equality between the two first hash keys is likewise checked at step 407 of FIG. 4a. The latter procedure may repeat (iteration loop 411 in FIG. 4a) for all the remaining rules in level-2 table 430, regardless of the bin each rule is currently in. This way, rules in level-2 table 430 that result in the same hash key1 as the rule being added 440 (and therefore they are referred to herein as “similar rules”), may populate bins in the new level-2 table 450 that are pointed at by the same respective second hash keys that were used with the original level-2 table 430. In other words, since the same hashing parameters (in this example parameters 424 and 425 associated with the rule being added) are applied to rules in the original level-2 table 430, then a rule that was “hashed” into bin_i (where i=1, 2, 3, and so on) of level-2 table 430 will be “hashed” into the same bin_i of the new level-2 table 450.

The bin in level-2 table 450 to which a similar rule should be inserted is found by applying to the similar rule the hashing data of the rule being added (hashing data 424 and 425 of rule 440, in this example). Although the same hashing data (of the rule being added) is applied to the similar rules, which are associated with the same first hash key (441), these rules will not necessarily populate one bin in level-2 table 450, because the rules are not identical.

If all of the rules in the original level-2 table 430 have been treated in the way described hereinabove, a condition that is checked at step 409, then, at step 412, the pointer p21 (426), which currently points at level-2 table 430, is substituted with a new pointer, p50 (480), to point (481) at the new level-2 table 450. Since the old pointer p21 (426) has been canceled, level-2 table 430 is no longer associated with entry 421 (482).

Turning again to FIG. 2, it is checked, at step 219, if there is a place for the rule being added (rule 440) in bin 462 of level-2 table 450. Since, according to the example shown in FIG. 4b, no rules from the original bin2 (432) have been copied to the new bin2 (462), there is now place in bin2 (462) for rule 440. Therefore, according to step 220 of FIG. 2, rule 440 may be added to bin2 (462). Of course, there might be cases where more than one rule will be copied or transferred to a bin to which a new rule is to be added. On the other hand, there might be cases where all of the rules will be transferred from bin 432 to bin 462. In the first type of cases, the rule being added will eventually be added to its intended bin. For example, rule 440 will be added (479) to its intended bin2 (462). In the second type of cases, an iteration loop 222 (FIG. 2) will take place.

Deleting a Level-2 Table

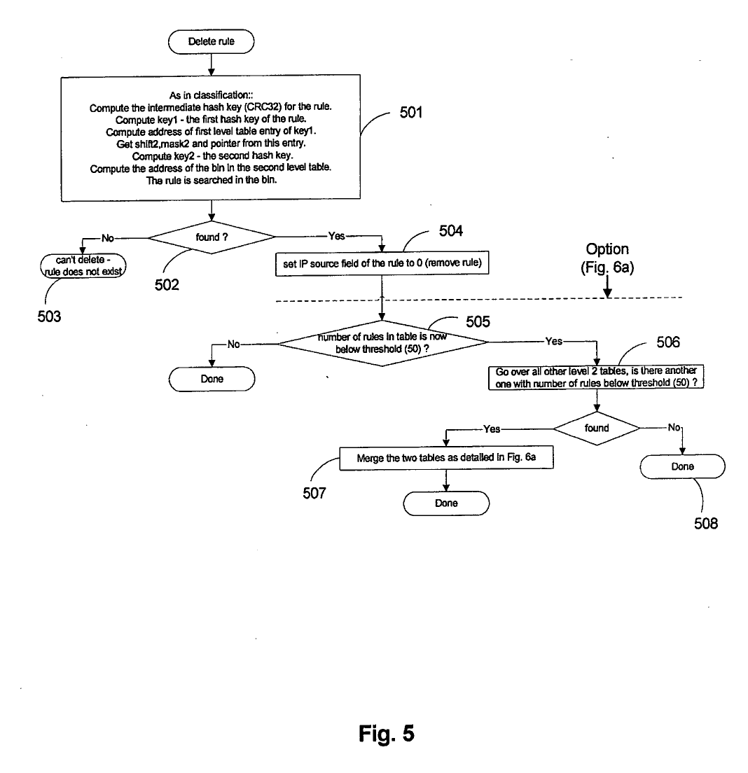

Referring now to FIG. 5, it shows an exemplary flowchart for deleting, or removing, a classification rule from a data structure, according to some embodiments of the present disclosure. In order to delete, or remove, a classification rule from a bin, that bin has first to be found. Accordingly, at step 501, the intermediate hash key (such as intermediate hash key 121 of FIG. 1) of the rule is computed, and the first hash key, that is a hash key1 (such as hash key1 123 of FIG. 1) of the rule is computed from the intermediate hash key. The computed hash key1 may point at an entry of the level-1 table (such as level-1 table 101 of FIG. 1).

The entry of the level-1 table may contain a pointer to a specific level-2 table and mask2 and shift2 parameters (the hashing data) to point at a specific bin in the specific level-2 table. The mask2 and shift2 parameters may, then, be used to compute a hash key2 (such as hash key2 124 of FIG. 1) of the rule from the intermediate hash key. The resulting hash key2 may then point at the specific bin within the specific level-2 table. Then, the classification rule is searched for in the specific bin.

If the rule is not found in the specific bin, a condition that is checked at step 502, then, at step 503, it is determined that the rule does not exist. If, however, the rule is found in the specific bin, then, at step 504, the rule may be removed, such as by clearing, in the bin, the IP (Internet Protocol) source address field of the rule. According to some aspects, the rule removal procedure may end at this stage. According to other aspects, once a rule is removed from (or cleared in) a given bin, the level-2 table in which the given bin resides may be merged with another level-2 table to save, thereby, memory space. In other words, merging is preferably performed if two level-2 tables are sparsely populated with rules.

According to some embodiments, if, after the removal of the rule from a given level-2 table, the number of rules in that table is equal to, or greater than, a first predetermined threshold number (“THN1”), a condition that is checked at step 505, then no tables will be merged and the rule deletion process will terminate at this stage. If, however, the number of rules in that table (hereafter referred to as a “first table”) is smaller than THN1, then a second level-2 table is searched for (506) in the data structure, in which the number of rules is smaller than a second predetermined threshold number (“THN2”). If such a second level-2 table is found, then, at step 507, a determination is reached to merge the first and the second level-2 tables. Otherwise (no such second level-2 table is found), no tables merging will occur, and the rule's deletion phase will terminate at this stage (508). Merging is generally performed by copying the content of the first and the second level-2 tables to a newly created table, and thereafter, deleting, or removing, the first and the second level-2 tables, thereby replacing two relatively sparsely populated tables with one, less sparsely populated, table. Merging two level-2 tables is optional. That is, deletion, or removal, of a rule may terminate at either step 503 or at step 504.

According to some embodiments, THN1 may be equal to THN2. According to some other embodiments, THN1 may differ from THN2. For example, both THN1 and THN2 may be equal to 50 (rules). In another example, THN1 may be equal to 50 and THN2 may be equal to 75. According to some aspects, the values of THN1 and THN2 are mutually independent. According to some other aspects, the values of THN1 and THN2 are mutually dependent. The values of THN1 and THN2 may be determined as tradeoff between memory size/management and performance speed.

Merging Two Existing Level-2 Tables to One New Level-2 Table

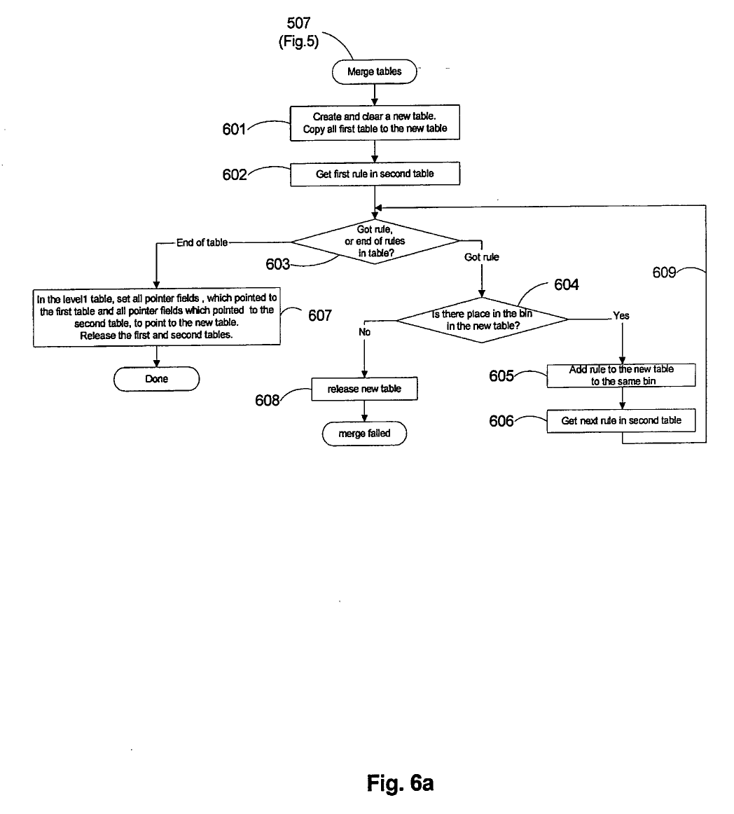

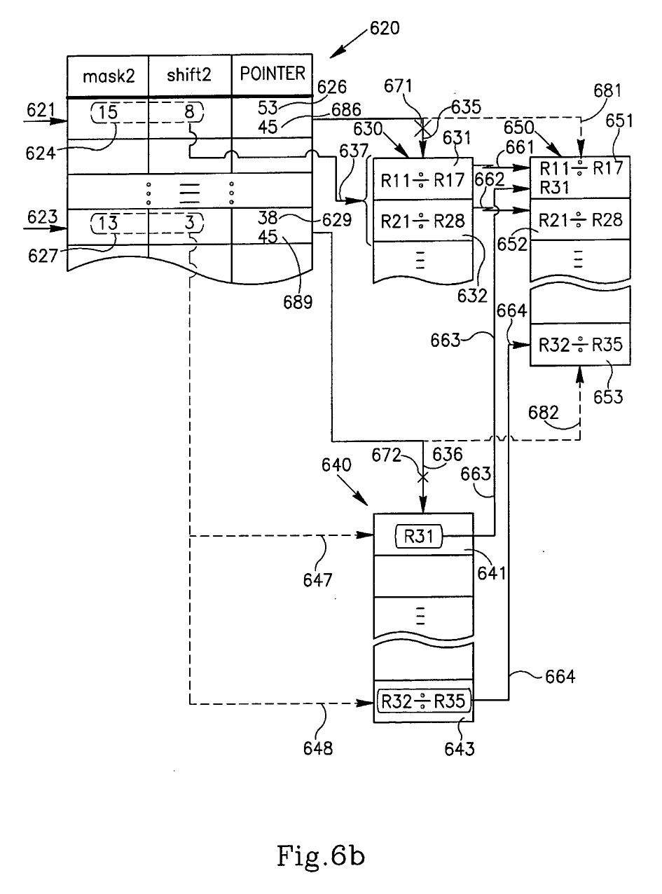

Referring now to FIG. 6a, it shows an exemplary flowchart for merging two, relatively sparsely populated, level-2 tables according to some embodiments of the present disclosure. As explained hereinbefore in connection with FIG. 5, if the merging option is positively considered, two level-2 tables will be merged only if both tables comply with the respective threshold values (THN1 and THN2).

At step 601, the rules contained in a first old level-2 table are added to (copied into) a newly created level-2 table. From this point on, rules will be copied, one rule at a time, from a second old level-2 table to the new level-2 table, a process that starts at step 602, where the first rule (symbolically referred to as “R1”) in the second old level-2 table is fetched. If there is a rule in the second old level-2 table that is to be transferred to the new level-2 table, a condition that is checked at step 603, then, at step 604, it is checked whether there is a place in an identical bin in the new level-2 table for that rule. In respect of a given rule in the second old level-2 table which is intended to be transferred to a new level-2 table, an identical bin is a bin in the new level-2 table whose index, or relative address, is identical to the index, or relative address, of the bin in the old level-2 table from which the rule is to be transferred. It is noted that during the merging process the shift2 parameter is not modified in any one of the level-1 table entries. Therefore, mapping of rules to bins in the new level-2 table is identical to the original mapping of the same rules to bins in the old level-2 table. For example, if a rule is to be transferred from bin number “i” in an old level-2 table, it will be transferred to bin number i in the new level-2 table; that is, provided that bin number i does not explode. Then, at step 605, the rule is added to that identical bin in the new level-2 table, and, at step 606, a next rule is searched for in the second level-2 table. As long as there is a next rule in the second level-2 table (step 603) and there is a place for it (the next rule) in the identical bin in the new level-2 table (step 604), transfer loop 609 will continue to iterate.

Transfer loop 609 will successfully terminate after all of the rules in the second level-2 table have been transferred to the new level-2 table and an “end-of-table” indication is generated to indicate that there are no more rules that are to be transferred, or copied, to the new level-2 table. When an end-of-table indication is generated (at step 603), then the pointers in the level-1 table that are currently pointing at the first and second level-2 tables are overridden, or replaced, by a new pointer that points at the new level-2 table, at step 607. It is noted that there may be cases where more then one pointer points both to the first level-2 table and to the second level-2 table. In such cases, all the pointers pointing at these tables may be replaced with the pointer that points at the new level-2 table. This way, the association between the level-1 table and the, now irrelevant, first and second level-2 table is broken, and a new association, between the level-1 table and the new level-2 table takes place in its stead. At this point, the old first and second level-2 tables may be deleted, or removed, from the data structure. An attempt to merge the first and second level-2 tables will fail if the transfer loop 609 terminates prematurely because one of the bins of level-2 table cannot hold additional rule(s) (step 604). In such a case, the merging procedure is aborted and the new table is deleted, at step 608, for failing to hold every rule in the first and in the second level-2 tables.

FIG. 6b schematically exemplifies merging two level-2 tables according to some embodiments of the present disclosure. Various steps in FIGS. 5 and 6a will now be described in conjunction with FIG. 6b to facilitate the understanding of the two level-2 table merging procedure. Level-1 table 620 has a plurality of entries such as exemplary entries 621 and 623. Exemplary entry 621 is shown containing exemplary second hashing data 624, which is shown consisting of exemplary second-level mask identifier (mask2) 15 and an exemplary second-level shift identifier (shift2) 8. Likewise, exemplary entry 623 is shown containing exemplary second hashing data 627, which is shown consisting of exemplary second-level mask identifier (mask2) 13 and an exemplary second-level shift identifier (shift2) 3. Entries of level-1 table 620 may contain also a pointer. For example, exemplary entries 621 and 623 are shown containing pointers 53 (626) and 38 (629), respectively. Pointer 53 (626) is shown pointing (635), prior to the merging, at an exemplary level-2 table 630 and pointer 38 (629) is shown pointing (636), prior to the merging, at level-2 table 640.

Level-2 table 630 consists of a plurality of bins, only two of which are shown, bin1 (631) and bin2 (632). Bin1 (631) is shown containing rules R11 to R17, for example. Bin2 (632) is shown containing rules R21 to R28, for example. Rules R11 through R17 and R21 through R28 are shown residing in bin1 (631) and bin2 (632) that are pointed at by a hash key2 that was computed by applying to them hashing data 624.

It is assumed that an exemplary rule R18 has been removed at step 504 of FIG. 5 and that level-2 table 630 contains, at this stage less than the first predetermined threshold number (“THN1”) of rules, which may be, say, 50 rules, for example. Level-2 table 630 is shown containing only 15 exemplary rules (rules R1 through R17 plus rules R21 through R28), for demonstration purpose. It is also assumed that there is a second level-2 table (640) that contains less than the second predetermined threshold number (“THN2”) of rules, which may be, say, 70 rules, for example. Level-2 table 640 is shown containing only 5 exemplary rules, rule R31 (in bin1, 641) plus rules R32 through R35, (in bin_1024, 643), for demonstration purpose. Therefore, according to steps 506 and 507 of FIG. 5, the two, relatively sparse, level-2 tables 630 and 640 are candidates for merging into one, more populated, level-2 table. Rules R31 and R32 through R35 are shown residing in two bins, bin1 (641) and in bin_1024 (643), that are pointed at by two second hash keys (647 and 648) that were computed by applying to hashing data 627 to these rules. A given hashing data, such as hashing data 627, may generate different hash keys2 because the resulting hash keys2 depend also on the rules themselves.

According to step 601 of FIG. 6a, a new level-2 table (650) is created and the rules of the first level-2 table 630 are copied into identical bins in the new level-2 table 650. That is, rules R11 through R17 in bin1 (631) of level-2 table 630 are copied (661) into identical bin1 (651) of level-2 table 650, and rules R21 through R28 in bin2 (632) of level-2 table 630 are copied (662) into identical bin2 (652) of level-2 table 650. According to step 602 of FIG. 6a, the first rule in the second level-2 table 640; that is, rule R31 in bin1 (641) is fetched. As explained hereinbefore, every rule in the first and in the second level-2 tables (the tables being merged) is copied into an identical bin in a new level-2 table. The rules are copied into identical bins because the respective hashing data (hashing data 624 for table 630 and hash data 627 for table 640) remain unchanged during the merging process. Therefore, rule R31 in bin1 (641) is, at this point, a candidate for copying (663) into bin1 (651) level-2 table 650, and rules R32 though R35 in bin_1024 (643) are, at this point, candidates for copying (664) into bin_1024 (653) level-2 table 650.

Bin1 (651) of level-2 table 650 includes only seven rules (R11 through R17), which is less than the assumed pre-determined maximum number of eight rules per bin. Therefore, there is still a place in bin1 (651) for one more rule, a condition that is checked at step 604 of FIG. 6a. Therefore, according to step 605 of FIG. 6a, rule R31 in bin1 (641) of level-2 table 640 is copied (663) into bin1 (651) of level-2 table 650 and the next rule in level-2 table 640 is fetched (at step 606 of FIG. 6a). Since, after copying the rules of level-2 table 630 into level-2 table 650, all of the bins in level-2 table 650, except bin1 (651) and bin2 (652), are still empty, new rules can be added, or copied, to them. In particular, the entire content of bin_1024 (643) of level-2 table 640 can be copied (664), as is, into the empty bin_1024 (653) of level-2 table 650.

Assuming that every rule in level-2 table 640 has been copied into level-2 table 650, a pointer pointing at the new level-2 table may replace the pointers pointing at the two (now old, irrelevant) level-2 tables. The condition relating to the latter assumption is checked at step 603 of FIG. 6a, and the pointers replacement is done according to step 607 of FIG. 6a. Turning again to the example shown in FIG. 6b, it is assumed that the pointer pointing at the new level-2 table 640 is has the exemplary value 45. Accordingly, according to step 607, the value 45 (686) replaces the value 53 (626) of the old pointer, resulting in disconnection (671) of the first old level-2 table 630 from entry 621 and connection (681) of new level-2 table 650 in its stead. Likewise, the value 45 (689) replaces the value 38 (629) of the old pointer, resulting in disconnection (672) of the second old level-2 table 640 from entry 623 and connection (682) of new level-2 table 650 in its stead.

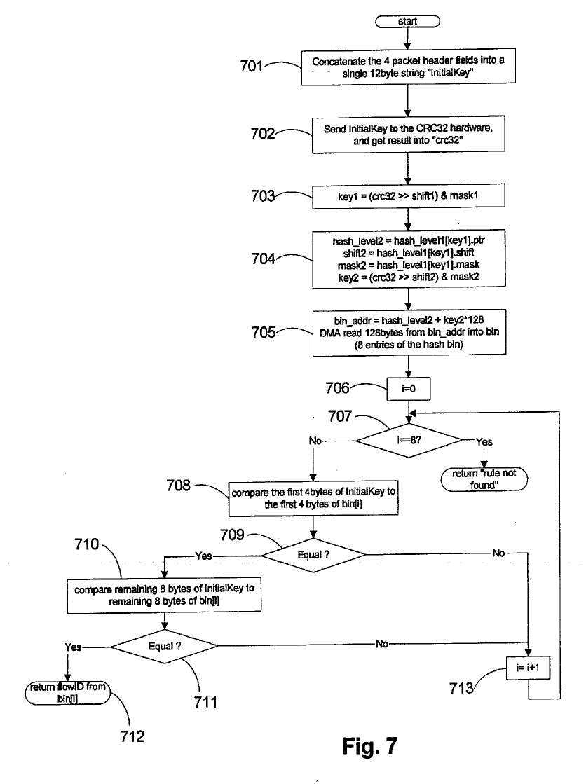

Referring now to FIG. 7, it shows an exemplary classification flowchart according to some embodiments of the present disclosure. Various steps in FIG. 7 will be described in conjunction with FIG. 1 to facilitate understanding of the search procedure. Upon receiving a packet, pre-selected fields of the packet's header (133) are concatenated, at step 701, to form a single bit string, initial key (120). The initial key (120) may be 12-byte long, though this is not necessarily so. At step 702, the initial key (120) is hashed by using CRC32 hardware, the result of which hashing is an intermediate hash key (121). It is noted that using CRC32 as a hashing function is only an example. Alternatively, or additionally, other hashing functions may be used as well. At step 703, the hash key1 (123) is calculated by employing first hash key parameters, mask1 and shift1. Key1 point (125) at an entry (126) of level-1 table. At step 704, a pointer (109) is obtained (“hash_level-2=hash_level-1[key1].ptr”), for pointing (110) to the corresponding level-2 table (level-2 table 102/1, in this example). Also obtained at step 704 are a shift2 parameter (“shift2=hash_level-1[key1].shift]”) and a mask2 parameter (127). Then, still at step 704, a hash key2 (124) is calculated by using the hashing parameters shift2 and mask2. At step 705, the hash key2 (124) is used as a pointer (135) to the corresponding hash bin (bin3, in this example). The next steps are used to access every rule in the bin, by initially setting a loop index i to 0 and incrementing the value of i by one, up to the predetermined maximum number of rules allowed for the bins. For demonstration purpose, it is assumed that the maximum number of rules allowed in each bin is eight (707). “i” is initially set to 0, at step 706. It is noted that for optimization purpose, it may be pre-determined that many of the bins will be populated with a number of rules that is smaller than eight, for example, one or two rules in a bin. This way, comparing a packet to rules and ending the iteration loop (i=i+1) may be much faster on the average. It is noted that by saying that a rule is stored or contained in a bin, it means that an initial key related to, or derived from, the rule is stored/contained in the bin, together with its related flow ID.

Accordingly, in accordance with some embodiments of the present disclosure, finding a flow ID for a received packet generally involves translation, or conversion, of the received packet into a packet's initial hash key, and comparing between the packet's initial hash key to rules' initial hash keys. If the packet's initial hash key matches a specific rule's initial hash key, then the flow ID associated with the matching rule's initial hash key is determined as the flow ID of the received packet. It is noted that, according to one approach, entire initial keys may be compared as a whole, or, according to a second approach, initial keys may be compared one portion, or field, at a time, to speed-up the overall performance. An example for the second approach is comparing four bytes of the packet's initial hash key against four bytes of rule's initial hash key. The next eight bytes (in this example) will be used in the comparison procedure if the first 4 bytes are equal.

If index “i” has not yet reached its maximum value (eight, in this example), a condition that is checked at step 707, then, at step 708 the four bytes of the packet's initial hash key are compared against four bytes of the initial hash key of rule i in the bin. If there is a match between the respective four bytes, a condition that is checked at step 709, then, at step 710 the respective eight bytes of the initial keys are also compared to one another. If there is a match between the respective eight bytes, a condition that is checked at step 711, then this means that there is a full match between the packet's initial hash key and the rule's initial hash key. Therefore, at step 712, the flow ID associated with the matching rule's initial hash key is used to process the received packet in the way specified by the flow ID. If there is no match between the respective eight bytes, then, at step 713 the index “i” is incremented by one, and the four bytes of the packet's initial hash key are compared against the four bytes of the next rule's initial hash key, at step 708, and so on.

Referring now to FIG. 8, it schematically illustrates a system according to an exemplary embodiment. Control processor 801 (sometimes referred to as a “host”) is responsible for operating the system 800 as a whole and, in particular, for operating higher-level protocol stacks, initialization code(s), control and management applications. Control processor 801 may be based on a high-performance general-purpose architecture and it may include instruction and data caches (802 and 803, respectively). Caches 802 and 803 hold, among other things, the most recently and most frequently used instructions and data variables. Control processor 801 executes the programs associated with the generation and update of the routing data structure, as described in connection with the flowcharts of FIGS. 2, 3a, 4a, 5, 6a and 7. One or more network processors 804/1 to 804/n may directly handle incoming data packets and execute the programs associated with the classification/searches, as described in connection with the flowchart of FIG. 7. One or more network processors 804 usually run applications relating to lower level communication software which handles level-2 and other types of communication protocols. The lower level communication software also handles some aspects of ingress and egress data processing. One or more network processors 804 have a direct access to the communication peripherals 805/1 to 805/m, and to hardware accelerators 806/1 to 806/n.

A network processor (804) typically has an internal (local) fast memory 807. Network processor 804 may access system memory 809 bus only via direct memory access (“DMA”) engine 808. However, accessing external memory 809 by network processor 804 often results in relatively long latencies and significant processing time. Network processor 804 may not have to wait until a DMA access is completed, but, rather, network processor 804 may perform other tasks while the DMA is accessed. For example, network processor 804 may run instruction codes relating to the packets' reception and transmittal operations performed by other peripheral(s). Network processor 804 may also run (while the DMA is accessed) instruction codes relating to queue scheduling, data buffer allocation or de-allocation. Tasks handling IP lookups have to wait for the result of the DMA before they can perform another task, or continue with the task at hand. According to some embodiments, the level-2 tables of the classification data structure are stored in system memory 809, whereas the level-1 table is stored in the internal, or local, memory 807, and the routing data structure is optimized in respect of the number of times that memory 809 is accessed by network processors 804.

According to some embodiments, a task performed by system 800 is handled either via a “fast path” or via a “slow path”. The fast path, which is handled by network processor 804, essentially encompasses all the activities done on the majority of data packets. Such activities may be associated, for example, with receiving via bus 820 data cells and/or data packets from a peripheral communication (805) and storing them in system memory 809. Such activities may be further associated, for example, with allocating and de-allocating data buffers, which are used for storing received packets; parsing protocol headers; classifying packets; data traffic policing; forwarding and queuing packets; scheduling output queues and sending data cells and/or data packets to peripherals 805 via bus 820. Data packets may roughly be divided into two main groups. Packets belonging to a first main group are intended to be routed, or relayed, by system 800 to a third party; that is, to a party other than system 800. Packets belonging to the second main group are intended for the control processor 801, in which case the control processor 801 may be the final destination for these packets. Therefore, a decision has to be reached (typically by network processor 804), regarding the main group a received packet belongs to. The slow path, which is handled by control processor 801, may encompass activities such as: initializations; generating and updating the classification data structure; memory management; management protocols; control protocols; errors handling and complex processing that may be needed for a small number of special packets.

In operation, a data packet may be received at communication peripherals 805 and forwarded to a network processor 804 via bus 820. Then, a copy of small, or some, fragment of the packet may be stored in local memory 807, whereas the entire packet may be assembled and stored in system memory 809. Network processor 804 may get from memory 809, via DMA engine 808, portions of the received packet that allow it to search in the data structure for a flow ID that is suitable for the received packet. The way the data packet should be handled is made by network processor 804 based on the steps specified in the flow ID that is found in the data structure for the received packet. Control processor 801 may update the routing data structure in system memory 809 while network processor 804 continues to receive and handle, on-the-fly, additional packets, via communication peripherals 805/1 to 805/m and via bus 820.

A major concern in using any routing data structure is the ability to update the classification data structure without interfering with the reception of data packets at communication peripherals 805 and without interfering with the classification rule lookup done by the network processor 804. Since both the control processor 801 and the network processor(s) 804 utilize the same classification data structure, they are designed in a way that control processor 801 may update data structures substantially at the same time the network processor 804 performs the classification rule lookup. The updates and concurrent classifications may be substantially performed without jeopardizing the integrity of the routing data structure because control processor 801 handles the updates in such a way that the data structure remains correct and coherent substantially at all times. For example, if a given entry of a level-1 table is involved in a given data structure update, then changing the content of that entry may be done by an “atomic write operation” by control processor 801, or alternatively, it may be done by the network processor when the network processor is requested to do so by control processor 804. By “atomic write operation” is meant that data is entered (“wrote”) to all fields of an entry in a way that if the network processor tries to read, during a search session, the entry's fields during a write operation (when the data structure is updated), the network processor will either read the entire old content of all the fields or the entire new content of these fields, but not both types (old and new) of content/data at the same read operation/cycle.

The classification of the packet may include triggering a single direct memory access (DMA) read cycle by a network processor 804/i, during which cycle the entire content of a bin of a level-2 table, in which a classification rule suitable for a received packet resides, is obtained and stored in the local memory 807/i for fast processing by the network processor 804/i. The fast processing may include identifying, or determining, the suitable rule in the bin (by the network processor), possibly among other, different rules that may also reside within that bin.

The elements enclosed by dotted box 810 may be an apparatus, or they may be implemented as one-microelectronic chip, for example a VLSI device. System memory 809 may be implemented as a separate chip/chips, due to the relatively large memory capacity required for storing therein multiple search tables (of a routing data structure), rules lists that are associated with the multiple tables and arrays that are temporarily generated by the control processor 801 while an updating process occurs.

The system disclosed herein (system 800) provides a practical and efficient rules search solution, because the generating and updating the data structure task and the searching for classification rules task are each performed by a different processor, as explained hereinbefore. The searches are done by a cheap and readily available network processor(s) (804), and in the worst case the number of processor's cycles required per search is about 50 to 75 cycles (for two to eight rules in a bin), and up to 2 memory accesses to system memory 809 may be required (per packet), with reasonable memory consumption and acceptable update complexity. The algorithms disclosed herein may be tailored to, or adapted for, a broad spectrum of communication processor hardware designs.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of generating a data structure for classifying an Internet protocol packet, comprising:
creating a level-2 table with a plurality of bins for storing therein classification rules;
using a first hashing data to derive a first hash key from a classification rule to designate an entry of a level-1 table, and populating said entry with a pointer to said level-2 table; and
populating a bin in said level-2 table with said classification rule, said bin being designated by a second hash key that is derived from said rule by using a second hashing data contained in said entry.

2. The method according to claim 1, wherein said first and second hashing data are applied to an intermediate key associated with the classification rule.

3. The method according to claim 2, wherein said intermediate key is obtained by hashing an initial key that is obtained by concatenating pre-selected fields of the classification rule.

4. The method according to claim 2, wherein said first hashing data comprises mask1 and shift1 hashing parameters and the second hashing data comprises mask2 and shift2 hashing parameters.

5. The method according to claim 3, wherein populating a bin with said classification rule comprises: inserting into said bin a flow identifier and an initial key with which it is associated.

6. The method according to claim 1, further comprising updating said data structure by adding to it a new classification rule, the addition comprising:
deriving a first hash key from said new classification rule, by using a first hashing data, to designate an entry of the level-1 table, the entry containing a second hashing data and maybe a pointer;
deriving a second hash key from said new rule, by using the second hashing data, for designating a bin in a level-2 table pointed at by the pointer or, if said pointer does not exist, for designating a bin in a newly created level-2 table; and
populating the bin with the new classification rule and, if the bin resides within a newly created table, populating the entry with a pointer to the newly created level-2 table.

7. The method according to claim 6, further comprising rebuilding the level-2 table if a bin in the level-2 table explodes during an attempt to add a rule and the level-2 table contains less then a predetermined number of rules (less than 200 rules, for example).

8. The method according to claim 7, further comprising splitting the level-2 table if either the rebuilding attempt fails or the level-2 table contains more than the predetermined number of rules and the level-2 table is designated by at least two pointers in the level-1 table.

9. The method according to claim 6, wherein the updating further comprises removal of a classification rule from the data structure.

10. The method according to claim 9, wherein the removal of a classification rule comprises:
deriving from the classification rule a first hash key by using a first hashing data to address an entry of the level-1 table, and using a second hashing data in the entry for generating a second hash key for addressing a bin in a level-2 table designated by a pointer in said entry; and
removing the classification rule from the designated bin.

11. The method according to claim 10, further comprising merging the level-2 table with a second level-2 table if the number of rules in the level-2 table is less than a first threshold number and the number of rules in the second level-2 table is less than a second threshold number.

12. A method of classifying an Internet protocol packet in a data structure, comprising:
deriving a first hash key from the packet, by using a first hashing data for obtaining a second hashing data and a pointer from an entry in a level-1 table;
deriving a second hash key from the packet, by using the second hashing data for designating a hash bin in a level-2 table designated by the pointer; and
obtaining from said hash bin a rule suitable for the packet and processing the packet according to a flow identifier associated with the suitable rule.

13. The method according to claim 12, wherein the first and second hashing data are applied to an intermediate key associated with the packet.

14. The method according to claim 13, wherein the intermediate key is obtained by hashing an initial key that is obtained by concatenating pre-selected fields of the packet.

15. The method according to claim 12, wherein the first hashing data comprises mask1 and shift1 hashing parameters and the second hashing data comprises mask2 and shift2 hashing parameters.

16. The method according to claim 14, wherein the initial key of the suitable rule and the initial key of the classification rule are identical.

17. The method according to claim 16, wherein suitability of a rule is determined by comparing a first portion of its initial key to a first portion of the initial key of the packet and, if identical, by comparing a second portion of its initial to a second portion of said packet.

18. A method of generating a data structure for classifying an Internet protocol packet, comprising:
populating an entry of a level-1 table, which is designated by a first hash key derived from a classification rule by using a first hashing data, with a pointer to a level-2 table and a second hashing data; and
populating a bin in said level-2 table with the classification rule, the bin being designated by a second hash key derived from the classification rule by using the second hashing data.

19. A method of associating an initial key to a bin in a level-2 table, comprising:
hashing the initial key to generate an intermediate key;
applying a first hashing data to said intermediate key to generate a first hash key for designating an entry of a level-1 table that contains a second hashing data and a pointer; and
applying said second hashing data to said intermediate key to generate a second hash key for designating a bin in a level-2 table designated by the pointer.

20. A method of classifying an Internet Protocol packet, comprising:
hashing data representative of a packet, by using 1^{st} hashing data, for designating an entry of level-1 table containing 2^{nd} hashing data useful for hashing said data for designating a bin in a level-2 table designated by a pointer contained in the entry; and
processing the packet according to a classification rule in the bin suitable for the packet.

21. An apparatus for generating a data structure and classifying a received Internet Protocol packet by using said data structure, comprising:
a network processor coupled to a direct memory access engine and comprising a local memory, said network processor being adapted to classify an Internet Protocol packet;
a control processor adapted to couple to an external memory system, and to generate and update a classification data structure by:
(1) populating an entry of a level-1 table, which is designated by a first hash key derived from a classification rule by using a first hashing data, with a pointer to a level-2 table and a second hashing data; and
(2) populating a bin in said level-2 table with the classification rule, the bin being designated by a second hash key derived from the classification rule by using said second hashing data; wherein said control processor stores said level-1 table in said local memory and said level-2 table in said external memory system.

22. The apparatus according to claim 21, wherein the direct memory access engine resides within the apparatus.

23. The apparatus according to claim 21, wherein the network processor classifies a received Internet Protocol packet by:
hashing data representative of said packet, by using first hashing data, for designating at an entry of said level-1 table which contains a second hashing data useful for hashing said data for designating at a bin in a level-2 table designated by a pointer that is contained in said entry; and
processing said packet according to a classification rule in said bin, which is suitable for said packet.

24. The apparatus according to claim 22, wherein the network processor generates the data representative of the packet by:
obtaining from the external memory system, via the direct memory access engine, the packet's header, or a portion thereof; and
concatenating pre-selected fields from said packet's header, or portion, to create an initial key and therefrom an intermediate key, said intermediate key being said data.

25. The apparatus according to claim 21, wherein the control processor, network processor and local memory are implemented as one microelectronic chip.

26. The apparatus according to claim 23, wherein classification of the packet comprises triggering a single direct memory access read cycle by the network processor, during which cycle the entire bin of a second level table in which a classification rule suitable for said packet is obtained.

27. The apparatus according to claim 21, wherein updating the data structure by the control processor and classifying Internet Protocol packets by the network processor are performed independently of one another.

28. The apparatus according to claim 27, wherein updating and classifying are performable substantially at the same time.

29. The apparatus according to claim 21, wherein changing the content of an entry of the data structure by the control processor during an update is done by performing an atomic write operation by said processor.

30. A data structure for classifying an Internet Protocol packet, comprising:
a level-1 table having one or more entries, wherein each entry, which may be designated by a first hash key derivable from an Internet Protocol packet by using a first hashing data, contains a pointer and a second hashing data;
one or more level-2 tables, each of which having a plurality of bins, at least some of which contain one or more classification rules;
wherein each one of said level-2 tables is designated by at least one pointer and each bin that contains a rule is designated by a second hash key that is derivable from said rule by using a second hashing data that is contained in the entry containing a pointer to the level-2 table associated with said bin.
